(19) United States
(12) Patent Application Publication
(10) Pub. No.: US 2016/0241399 A1
(43) Pub. Date: Aug. 18, 2016

(54) Efficient Privacy-Preserving Ciphertext-Policy Attribute Based Encryption and Broadcast Encryption

(71) Applicants: Dijiang HUANG, Chandler, AZ (US); Zhibin ZHOU, Bellevue, WA (US)

(72) Inventors: Dijiang HUANG, Chandler, AZ (US); Zhibin ZHOU, Bellevue, WA (US)

(73) Assignee: Arizona Board of Regents on behalf of Arizona State University, Scottsdale, AZ (US)

(21) Appl. No.: 14/216,202

(22) Filed: Mar. 17, 2014

Related U.S. Application Data
(60) Provisional application No. 61/790,255, filed on Mar. 15, 2013.

(51) Int. Cl. H04L 9/30; H04L 9/08; H04L 29/06

(52) U.S. Cl. CPC H04L 9/30; H04L 63/0421; H04L 9/3073; H04L 9/0861

(57) ABSTRACT

A new construction of CP-ABE, named Privacy Preserving Constant CP-ABE (PPC-CP-ABE) that significantly reduces the ciphertext to a constant size with any given number of attributes is disclosed. PPCCP-ABE leverages a hidden policy construction such that the recipients' privacy is preserved efficiently. A Privacy Preserving Attribute Based Broadcast Encryption (PP-AB-BE) scheme is disclosed. PP-AB-BE is flexible because a broadcasted message can be encrypted by an expressive hidden access policy, either with or without explicit specifying the receivers. PP-AB-BE significantly reduces the storage and communication overhead. Also, PP-AB-BE attains minimal bound on storage overhead for each user to cover all possible subgroups in the communication system.

### CROSS-REFERENCE TO RELATED APPLICATIONS

This application claims priority to U.S. Provisional Application No. 61/790,255, entitled “Efficient Privacy-Preserving Ciphertext-Policy Attribute Based Encryption And Broadcast Encryption,” filed Mar. 15, 2013, the entire contents of which is specifically incorporated by reference herein without disclaimer.

This application is related to Provisional Patent Application No. 61/788,552 [Attorney Docket No. AZTE.P0103US.P1], entitled “Enabling Comparable Data Access Control For Lightweight Mobile Devices In Clouds,” filed Mar. 15, 2013, the entire disclosure of which is hereby incorporated by reference.

### STATEMENT REGARDING FEDERALLY SPONSORED RESEARCH OR DEVELOPMENT

This invention was made with government support under Grant No. N00014-10-1-0714 awarded by The Office of Naval Research (Navy/ONR). The government has certain rights in the invention.

### BACKGROUND

1. Field of the Invention

The present invention relates generally to encryption. More particularly, it relates to Ciphertext Policy Attribute Based Encryption (CP-ABE).

2. Description of Related Art

Ciphertext Policy Attribute-Based Encryption (CP-ABE) has been a very active research area in recent years. In the construction of CP-ABE, each attribute is a descriptive string and each entity may be tagged with multiple attributes. Many entities may share common attributes, which allow message encryptors to specify a secure data access policy over the shared attributes to reach a group of receivers. A decryptor's attributes need to satisfy the access policy in order to recover the message. These unique features make CP-ABE solutions appealing in many systems, where expressive data access control is required for a large numbers of users. One major problem of existing CP-ABE schemes is that they do not consider the anonymity of data recipients and the data access policies are attached to the ciphertexts in plaintext form. Thus, passive attackers can track a user or infer the sensitivity of ciphertext by eavesdropping on the access policies. In many environments, it is also critical to protect the access policies as well as the data content. For example, the access policy “General” AND “Pentagon” disclose the recipient's roles or positions and implies the sensitivities of the message. On the other hand, existing CP-ABE schemes require bulky, linearly increasing ciphertext size. For example, the message size in BSW-CP-ABE starts at about 630 bytes, and each additional attribute adds about 250-300 bytes. To the best of our knowledge, there is no work that can achieve privacy-preservation and constant ciphertext size in the same time.

An Identity Based Encryption (IBE) scheme has been proposed. In IBE, an identity or ID is a string one-to-one mapped to each user. A user can acquire a private key corresponding to his/her ID in an off-line manner from trusted authority and the ID is used as public key. The ciphertext encrypted by a particular ID can only be decrypted by the user with corresponding private key, i.e., the encryption is one-to-one.

Attribute Based Encryption (ABE) has been proposed as a version of IBE where an identity is viewed as a set of descriptive attributes. The private key for an identity w can decrypt the message encrypted by the identity w′ if and only if w and w′ are closer to each other than a pre-defined threshold in terms of set overlap distance metric. Other versions of ABE further generalize the threshold-based set overlap distance metric to expressive access policies with AND and OR gates. Two main variants of ABE have been proposed, namely Key Policy Attribute Based Encryption (KP-ABE) and Ciphertext Policy Attribute Based Encryption (CP-ABE). In KP-ABE, each ciphertext is associated with a set of attributes and each user's private key is embedded with an access policy. Decryption is enabled only if the attributes on the ciphertext satisfy the access policy of the user's private key. In CP-ABE, each user has a set of attributes that associate with user's private key and each ciphertext is encrypted by an access policy. To decrypt the message, the attributes in the user private key need to satisfy the access policy. CP-ABE is more appealing since it is conceptually closer to a Role Based Access Control (RBAC) model.

Although ABE schemes have shown their strong capability to construct a flexible data access control model, existing ABE schemes suffer from large ciphertext size problems. A CP-ABE scheme has been proposed having constant ciphertext size. However, this scheme does not support wildcards (or do-not-care) in its access policy, which makes the number of access policies increase exponentially. Moreover, to decrypt a ciphertext, the decryptor's attributes need to be identical to the access policy. In other words, the model is still one-to-one (i.e., an access policy is satisfied by one attribute list or ID). Thus, this scheme can be simply implemented using IBE schemes with same efficiency by using each user's attribute list as his/her ID. Another general construction of CP-ABE uses constant ciphertext independently.

This scheme achieves constant ciphertext with any monotonic threshold data access policy, e.g. n-of-n (AND), 1-of-n (OR) and m-of-n.

ABE can be used as a perfect cryptographic building block to realize Broadcast Encryption (BE). In BE, a broadcaster encrypts a message for some set of users who are listening to a broadcasting channel and use their private keys to decrypt the message. Compared with traditional one-to-one encryption schemes, BE is very efficient. Instead of sending messages encrypted with each individual recipient's public key, the broadcast encryptor broadcasts one encrypted message to be decrypted by multiple eligible recipients with their own private keys.

The encryptor in the existing BE schemes needs to specify the receiver list for a particular message. In many scenarios, it is very hard to know the complete receiver list and it is desirable to be able to encrypt without exact knowledge of possible receivers. Also, existing BE schemes can only support simple receiver list. It is hard to support flexible, expressive access control policies. An broadcast encryption with attribute based mechanism has been proposed where expressive attribute based access policy replaces the flat receiver list. Also, CP-ABE and flat-table mechanisms can be used to minimize the number of messages and support expressive access policy.

Based on different tradeoffs between storage and communication overhead, existing BE schemes can be generally categorized into the following classes: (1) constant ciphertext, linear public and/or private key on number of total receivers; (2) linear ciphertext on number of revoked receivers, constant (or logarithm) public and/or private key; and (3) sublinear ciphertext, sublinear public and/or private key. If the number of excluded or revoked receivers is denoted as r and the total number of receivers as N, class (1) is more suitable for the case (N−r)<<N, class (2) is more efficient when r<<N, and class (3) can be used in most cases with balanced performance.

Although existing class (1) BE schemes feature constant ciphertext size, the number of public/private keys each user needs to perform encryption/decryption is linearly proportional to the maximum number of non-colluding users in the system. In the case of the fully collusion-resistant BE systems, the number of public keys each user needs to store equals the number of users in the system. In a system with N users, where N is a large number, e.g., 2³², the set of public keys {PKᵢ|=1 . . . N} is huge and is impossible for each user to pre-load all public keys. Although it is possible to follow a PKI manner to issue a certificate for each user, the encryptor needs to contact each recipient to acquire the certificate or the encryptor needs to download the public keys from a centralized server. This process is very costly and greatly undermines the efficiency of BE. Although class (3) schemes try to reduce the complexity of storing public keys to sublinear, the size of ciphertext is also increased to sublinear, which can still be huge in a large system. As for the class (2) BE schemes, they are very efficient when r<<N. However, as the value of r increases, the efficiency of class (2) schemes drops linearly.

### SUMMARY

Some embodiments of the present disclosure comprise a method for providing attribute-based encryption of a message. In some embodiments, the method comprises generating a public key PK and a master key MK, each public key PK being mapped to an attribute value. In some embodiments, the method comprises generating a private key for a user based on the public key PK, the master key MK and a user's attribute list L. In some embodiments, the method comprises specifying an access policy W by assigning an attribute for each available attribute. In some embodiments, the method comprises producing cyphertext CT utilizing the public key PKs of the attribute values of the access policy W and a message M as input. In some embodiments, the ciphertext associates an anonymized access policy W̅. In some embodiments, only a user with an attribute list L satisfying the access policy W can decrypt the cyphertext CT.

In some embodiments, the access policy may enforce hidden conjunctive access policies with wildcards in constant ciphertext size. In some embodiments, the user's attribute list L may be defined in accordance with the following definition:

Definition 1: A user's attribute list is defined as L={L[i]_{i ε[1,k}]}, where L[i]ε{Aᵢ⁺, Aᵢ⁻} and k is the number of attributes in the universe. □

In some embodiments, the method may utilize a hidden AND-gate policy constructed in accordance with the following definition:

Definition 2: Let W={W[i]}_{iε[1,k]} be an AND-gate access policy, where W[i]ε{Aᵢ⁺, Aᵢ⁻, Aᵢ*}. We use the notation L|=W to denote that the attribute list L of a user satisfies W, as:

L|=W [symbol] W⊂L∪{Aᵢ*}_{iε[i,k]}.□

In some embodiments, the method may utilize an anonymized AND-gate policy constructed in accordance with the following definition:

Definition 3: Let W̅=W∩{Aᵢ*}_{iε[i,k]} be an anomymized AND-gate access policy.

In some embodiments, the anonymity set of a blinded policy W̅ may be a set of access policies which are identically blinded to W̅. In some embodiments, the method may further comprise decrypting ciphertext CT using the public key PK, the private key SK of the user and the ciphertext CT if the user's attribute list L satisfies the anonymized access policy W̅. In some embodiments, the method may be utilized for broadcast encryption.

In some embodiments, the method may include the step of constructing a local guess of access policy W̅. In some embodiments, the step of constructing a local guess may utilize the following algorithm:

Algorithm 1 Construct local guess \tilde{W}

```
Initialize \tilde{W} = W̅
for i = 1 to k do
  if W̅[i] == Aᵢ* then
    \tilde{W}[i] = Lᵤ[i];
  end if
end for
return \tilde{W};
```

In some embodiments, a method of encrypting a message M for broadcast comprises issuing each user an n-bit binary ID. In some embodiments, N represents the number of users and n=log N. In some embodiments, the method further comprises assigning each user bit-assignment attributes to represent bit values in their ID. In some embodiments, the method further comprises choosing m descriptive attributes for the system. In some embodiments, the method further comprises generating public and private keys utilizing n and m. In some embodiments, the method further comprises specifying an access policy W utilizing either descriptive attributes or bit-assignment attributes. In some embodiments, the method further comprises encrypting the message M utilizing an encryption algorithm utilizing public key and the access policy.

In some embodiments, a non-transitory computer readable medium stores a program causing a computer to execute a process of generating a public key PK and a master key MK, each public key PK being mapped to an attribute value. In some embodiments, the process comprises generating a private key for a user based on the public key PK, the master key MK and a user's attribute list L. In some embodiments, the process comprises specifying an access policy W by assigning an attribute for each available attribute. In some embodiments, the process comprises producing cyphertext CT utilizing the public key PKs of the attribute values of the access policy W and a message M as input. In some embodiments, the ciphertext associates an anonymized access policy W̅. In some embodiments, only a user with an attribute list L satisfying the access policy W can decrypt the cyphertext CT.

In some embodiments, the method contained on the non-transitory computer readable medium may use an access policy that enforces hidden conjunctive access policies with wildcards in constant ciphertext size.

In some embodiments, the method contained on the non-transitory computer readable medium may utilize a user attribute list L defined in accordance with the following definition:

Definition 1: A user's attribute list is defined as L={L[i]_{i ε[1,k]}}, where L[i]ε{Aᵢ⁺, Aᵢ⁻} and k is the number of attributes in the universe. □

In some embodiments, the method contained on the non-transitory computer readable medium may utilize a hidden AND-gate policy constructed in accordance with the following definition:
Definition 2: Let W={W[i]}_{iε[1,k]} be an AND-gate access policy, where W[i]ε{Aᵢ⁺, Aᵢ⁻, Aᵢ*}. We use the notation L|=W to denote that the attribute list L of a user satisfies W, as:

L|=W [symbol] W⊂L∪{Aᵢ*}_{iε[i,k]}.□

In some embodiments, the method contained on the non-transitory computer readable medium may utilize an anonymized AND-gate policy constructed in accordance with the following definition:
Definition 3: Let W̅=W∩{Aᵢ*}_{iε[i,k]} be an anomymized AND-gate access policy.

In some embodiments, the method contained on the non-transitory computer readable medium may utilize an anonymity set of a blinded policy W which are identically blinded to W̅.

In some embodiments, the method contained on the non-transitory computer readable medium may further comprise instructions for decrypting ciphertext CT using the public key PK, the private key SK of the user and the ciphertext CT if the user's attribute list L satisfies the anonymized access policy W̅. In some embodiments, the decryption method may include the step of constructing a local guess of access policy \check{W}.

In some embodiments, the step of constructing a local guess may utilize the following algorithm:

Algorithm 1 Construct local guess \tilde{W}

```
Initialize \tilde{W} = W̅
for i = 1 to k do
  if W̅[i] == Aᵢ* then
    \tilde{W}[i] = Lᵤ[i];
  end if
end for
return \tilde{W};
```

In some embodiments, an encryption device comprises a processor and a memory coupled to said processor, wherein said processor is configured with logic to execute a process in accordance with any one of the preceding methods.

### BRIEF DESCRIPTION OF THE DRAWINGS

FIGS. 1 and 2 depict an exemplary embodiment of the disclosed system that illustrates ID and bit-assignment attributes distribution.

FIG. 3 depicts an exemplary embodiment of the disclosed system that illustrates worst cases of broadcast encryption to N/2 receivers.

FIG. 4 depicts an exemplary embodiment of the disclosed system that illustrates a number of messages in a system with 512 users.

FIG. 5 depicts an exemplary embodiment of the disclosed system that illustrates a number of messages in a system with 1024 users.

FIG. 6 depicts an exemplary embodiment of the disclosed system that illustrates a total size of messages in a system with 512 users.

FIG. 7 depicts an exemplary embodiment that of the disclosed system illustrates a total size of messages in a system with 1024 users.

### DESCRIPTION OF ILLUSTRATIVE EMBODIMENTS

In the following detailed description, reference is made to the accompanying drawings, in which are shown exemplary but non-limiting and non-exhaustive embodiments of the invention. These embodiments are described in sufficient detail to enable those having skill in the art to practice the invention, and it is understood that other embodiments may be used, and other changes may be made, without departing from the spirit or scope of the invention. The following detailed description is, therefore, not to be taken in a limiting sense, and the scope of the invention is defined only by the appended claims. In the accompanying drawings, like reference numerals refer to like parts throughout the various figures unless otherwise specified.

A novel PPC-CP-ABE construction, named Privacy Preserving Constant-size Ciphertext Policy Attribute Based Encryption (PPC-CP-ABE), which enforces hidden access policies with wildcards and incurs constant-size conjunctive headers, regardless of the number of attributes is disclosed. In some embodiments, each conjunctive ciphertext header only requires 2 bilinear group elements, which are bounded by 100 bytes in total 1. To support disjunctive or more flexible access policies, multiple constant-size conjunctive headers can be attached to the same ciphertext message. Each ciphertext header may be restricted to be conjunctive in order to avoid ambiguity while preserving receivers' anonymity. Moreover, PPC-CP-ABE may support non-monotonic data access control policy. This construction may achieves privacy preservation and constant-size conjunctive headers with wildcards.

In some embodiment, a new construction named Privacy Preserving Attribute Based Broadcast Encryption (PP-AB-BE) is presented. In existing BE schemes, a sender encrypts a message for an specified set of receivers who are listening on a broadcast channel. Each receiver in the specified set can decrypt the message while all other listeners cannot decrypt even though they collude together. However, in large scale system, identifying every receiver, and acquiring and storing their public keys are not easy tasks. For example, to broadcast a message to all CS students in a university, the encryptor may query the CS department roster and acquire the public key of every student in the roster; this process could be very expensive and time consuming.

Using PP-AB-BE, an encryptor may have the flexibility to encrypt the broadcasted data either with or without the exact information of intended receivers. In exemplary embodiment, Alice can specify a hidden access policy: “CS” AND “Student” to restrict the broadcast message to all CS students without specifying the receivers explicitly. Accordingly, Bob, who has attributes {“EE”, “Student”}, cannot decrypt the data while Carol, who has attributes {“CS”, “Student”} can access the data. Moreover, Alice can also encrypt the broadcasted message to any arbitrary set of receivers such as {“Bob”, “Carol”}.

In some embodiments, PP-AB-BE also significantly reduces the storage overhead compared to many existing BE schemes, where cryptographic key materials required by encryption or decryption increase linearly or sublinearly on the number of receivers. For example, in BGW scheme, the public key size is O(N) or O(N1=2), where N is the number of users in the system. PP-AB-BE may reduce the key storage overhead problem by optimizing the organization of attribute hierarchy. In a system with N users, the storage overhead may be O(log N+m), where m is a constant number and m<<N. In some embodiments, PP-AB-BE may achieve storage lower bound to satisfy all possible subgroup formations, and thus it can be applied to storage constrained systems.

A fundamental and unified Privacy Preserving Attribute Based solution considering constraints on both communication and storage that is provably secure is disclosed. In some embodiments, PPC-CP-ABE can be used to implement an identity based encryption with wildcards (WIBE) to achieve a constant ciphertext size WIBE construction with privacy preserving features.

In some embodiments, an efficient Privacy Preserving Constant Ciphertext Policy Attribute Based Encryption (PPC-CP-ABE) scheme may enforce hidden conjunctive access policies with wildcards in constant ciphertext size.

A Privacy Preserving Attribute Based Broadcast Encryption (PP-AB-BE) scheme, based on PPC-CP-ABE, is also disclosed. Compared with existing BE schemes, PP-AB-BE may be flexible as it uses both descriptive and non-descriptive attributes. This may enable a user to specify the decryptors based on different abstraction levels, with or without exact information of intended receivers. Moreover, PP-AB-BE may demand less storage overhead compared to existing BE schemes.

### Models

In some embodiments of PPC-CP-ABE, attributes may be used to form a data access policy. In some embodiments, let U={A₁, A₂, . . . , Aₖ} be the Universe of attributes in the system. Each Aᵢ may have three values: {Aᵢ⁺, Aᵢ⁻, Aᵢ*}. When a user u joins the system, u may be tagged with an attribute list.

In some embodiments, let U={Aᵢ}_{iε[1,k]} be the Universe of attributes in the system. Each Aᵢ may have three values: {Aᵢ⁺, Aᵢ⁻, Aᵢ*}. When a user u joins the system, u may be tagged with an attribute list. A user's attribute list may be defined as L={L[i]_{iε[1,k]}}, where L[i]ε{Aᵢ⁺, Aᵢ⁻} and k may be the number of attributes in the universe.

In some embodiments, Aᵢ⁺ denotes the user has Aᵢ. In some embodiments, Aᵢ⁻ denotes that the user does not have Aᵢ or that Aᵢ is not a proper attribute of this user. For example, suppose U={A₁=CS, A₂=EE, A₃=Faculty, A₄=Student}. Alice is a student in CS department: Bob is a faculty in EE department: Carol is a faculty holding a joint position in EE and CS department. Their attribute lists are illustrated in Table I:

TABLE I
Attribute Examples.

| | | | | |
|---|---|---|---|---|
| Attributes | L[1] | L[2] | L[3] | L[4] |
| Description | CS | EE | Faculty | Student |
| Alice | A₁⁺ | A₂⁻ | A₃⁻ | A₄⁺ |
| Bob | A₁⁻ | A₂⁺ | A₃⁺ | A₄⁻ |
| Carol | A₁⁺ | A₂⁺ | A₃⁺ | A₄⁻ |

In some embodiments, as the actual data access policy is hidden in the ciphertext header, effective measures are required to avoid ambiguity. In other words, when a decryptor receives a ciphertext header without knowing the access policy, he/she should not try a large number of access policies when performing decryption. To this end, an AND-gate policy construction may be used so that each decryptor only needs to try once on each ciphertext header.

In some embodiments, a hidden AND-gate access policy may be used. Let W={W[i]_{iε[1,k]}} be an AND-gate access policy, where W[i]ε{Aᵢ⁺, Aᵢ⁻}. The notation L|=W may be used to denote that the attribute list L of a user satisfies W, as:

L|=W [symbol] W⊂L∪{Aᵢ*}_{iε[1,k]}

In some embodiments, Aᵢ⁺ or Aᵢ⁻ requires the exact same attribute in user's attribute list. As for Aᵢ*, it may denote a wildcard value, which means the policy does not care the value of attribute Aᵢ. Effectively, each user with either Aᵢ⁺ or Aᵢ⁻may fulfill Aᵢ* automatically.

In some embodiments, an anonymized AND-gate policy that removes ail identifying attribute values, i.e. {Aᵢ⁺, Aᵢ⁻}, except do-not-care values, i.e. Aᵢ* may be used. Let W̅=W∩{Aᵢ*}_{iε[1,k]} be an anonymized AND-gate access policy.

As an example shown in Table II, an access policy W₁ for all CS students and an access policy W₂ for all CS people can be specified.

TABLE II
An Example of Access Policies and Anonymized Policies.

| | | | | |
|---|---|---|---|---|
| Attributes | W[1] | W[2] | W[3] | W[4] |
| Description | CS | EE | Faculty | Student |
| W₁ | A₁⁺ | A₂⁻ | A₃⁻ | A₄⁺ |
| W̅₁ | Aᵢ* | Aᵢ* | Aᵢ* | Aᵢ* |
| W₂ | A₁⁺ | A₂⁻ | A₃* | A₄* |
| W̅₂ | Aᵢ* | Aᵢ* | A₃* | A₄* |

*where Aᵢ* represents “do not care”.

In some embodiments, the anonymity policy is defined as the state of being not identifiable within a set of subjects, i.e., the anonymity set. As the access policy may be one-to-many mapped to users, the anonymity set of a blinded policy W̅ may be the set of access policies which are identically blinded to W̅.

In some embodiments, an analysis of the anonymity level of the blinded access policy may be performed. Firstly, if there are no wildcards in the original access policy (hidden), the blinded policy W̅ may be empty. In this case, the size of anonymity set may be 2^{k}, as there may be 2^{k} possible access policies blinded to W̅. If there are j wildcards in the original access policy (hidden), the size of anonymity set may be 2^{k-j}.

In some embodiments, pairing is a bilinear map function e: [symbol] ₀× [symbol] ₀→ [symbol] ₁ where [symbol] ₀ and [symbol] ₁ are two multiplicative cyclic groups with large prime order p. Pairing may have the following properties:

Bilinearity:

e(P^{a},Q^{b})=e(P,Q)^{ab},∀P,Qε [symbol] ₀,∀a,bε [symbol] ₚ*.

[symbol]

Nondegeneracy:

e(g,g)≠1 where g is the generator of [symbol] ₀.

Computability: there exists an efficient algorithm to compute the pairing.

In some embodiments, the security of PPC-CP-ABE is based on a complexity assumption called the Bilinear Diffie-Hellman Exponent assumption (BDHE).

In some embodiments, [symbol] ₀ may be a bilinear group of prime order p. The K-BDHE problem in [symbol] ₀ may be stated as follows: given the following vector of 2K+1 elements (Note that the g^{a}^{^{K+1}} is not in the list):

(h,g,g^{a},g^{(a}^{²}⁾, . . . ,g^{a}^{^{K}},g^{a}^{^{K+2}}, . . . ,g^{a}^{^{2K}})ε [symbol] ₀²^{^{K+1}}

as the input and the goal of the computational K-BDHE problem is to output e(g, h)″(+¹. The set can be denoted as:

Y_{g,a,K}={g^{a},g^{(a}^{²}⁾, . . . ,g^{a}^{^{K}},g^{a}^{^{K+2}}, . . . ,g^{a}^{^{2K}}}.

In some embodiments, the decisional K-BDHE assumption is said to be hold in [symbol] ₀ if there is no probabilistic polynomial time adversary who is able to distinguish

<h,g,Y_{g,a,K},e(g,h)^{a}^{^{(k+1}}⁾>

and

<h,g,Y_{g,a,K},e(g,h)^{R}>

with non-negligible advantage, where a, Rε [symbol] ₚ and g, hε [symbol] ₀ are chosen independently and uniformly at random.

### PPC-CP-ABE Construction

In some embodiments, the PPC-CP-ABE scheme uses four fundamental algorithms: the Setup algorithm, the KeyGen algorithm, the Encrypt algorithm, and the Decrypt algorithm.

The Setup algorithm Setup(k) may take input k as the number of attributes in the system. The algorithm may then return public key PK and master key MK. The public key may be used for encryption while the master key may be used for private key generation.

The KeyGen algorithm KeyGen(PK, MK, L) may take the public key PK, the master key MK and the user's attribute list L as inputs. The algorithm may then output the private key of the user.

The Encrypt algorithm Encrypt (PK, W, M) may take the public key PK, the specified access policy W and the message M as inputs. The algorithm may then output ciphertext CT such that only a user with an attribute list satisfying the access policy can decrypt the message. The ciphertext also associates the access policy W.

The Decrypt algorithm Decrypt(PK, SK, CT) may decrypt the ciphertext when the user's attribute list satisfies the access policy specified in the ciphertext. It may take the public key PK, the private key SK of the user, and the ciphertext CT as inputs. The algorithm may return the plaintext M if L|=W, where L is the user's attribute list and W is the access policy.

In some embodiments, a broadcast encryption construction with constant ciphertext size may be used, where the broadcast encryptor uses the public key list corresponding to intended receivers to perform encryption. To make the ciphertext constant, each receiver's public key may be multiplied together, assuming a multiplicative group structure. Thus, the result ciphertext may still be an element of the group, i.e., the ciphertext is constant size.

In some embodiments, each public key is mapped to an attribute value, including Aᵢ. To encrypt a message, the encryptor may specify an access policy W by assigning an attribute value (Aᵢε{1,0,*}) for each of the n attributes in a Universe. The encryptor may then encrypt the message using public keys of the attribute values in the W. Each decryptor generates a set of private key components corresponding to his/her attribute list L. In some embodiments, all the private key components of the same user are tied together by a common random factor to prevent collusion attacks.

In some embodiments, there are k attributes {A₁, A₂, . . . , Aₖ} in the system. In this case, K=3k attributes values since each attribute Aᵢ has 3 values: {Aᵢ⁺, Aᵢ⁻, Aᵢ*}. For ease of presentation, {A₁⁺, A₂⁺, . . . , Aₖ} to 1, . . . , k, {A₁⁺, A₂⁺, Aₖ⁺} may be mapped to k+1, . . . , 2k and k wildcards {A₁*, A₂* . . . , Aₖ} may be mapped to 2k+1, . . . , 3k as in Table III:

TABLE III
Mapping Attribute Values to Numbers.

| Attributes | A₁ | A₂ | A₃ | . . . | Aₖ |
|---|---|---|---|---|---|
| + | 1 | 2 | 3 | . . . | k |
| − | k + 1 | k + 2 | k + 3 | . . . | 2k |
| * | 2k + 1 | 2k + 2 | 2k + 3 | . . . | 3k |

In some embodiments, [symbol] ₀ may be the bilinear group of prime order p. A Trusted Authority (TA) may first pick a random generator gε [symbol] ₀ and a random aε [symbol] ₚ. The TA may compute gᵢ=g^{(a}^{ⁱ}⁾ for i=1,2, . . . , K,K+2, . . . , 2K where K=3k. In some embodiments, TA picks a random γε [symbol] ₚ and sets v=g^{γ}ε [symbol] ₀. The public key may be:

PK=(g,g₁. . . ,g_{K},g_{K+2}, . . . ,g_{2K},r)ε [symbol] ₀^{2K+1}.

The master key MK={γ,α} may be guarded by the TA.

In some embodiments, each user u is tagged with the attribute list Lᵤ={Lᵤ[i]_{iε[1,k]}} when joining the system, where 1≦Lᵤ[i]≦2k. The TA may first select k random numbers {rᵢ}_{iε[1,k]} from [symbol] ₚ and calculate r=Σᵢ₌₁^{k} rᵢ

In some embodiments, the TA computes D=g^{γr}=v^{r}. For ∇iε[1,k], TA may calculate Dᵢ=g^{γ(a}^{^{L}}^{u[i]+r}^{ᵢ}⁾=g^{γr}^{ᵢ} and Fᵢ=g^{γ(a}^{^{2k+i}}^{+r}^{ᵢ}⁾=g₂ₖ₊ᵢ^{γ}·g^{γr}^{ᵢ}.

In some embodiments, the private key for user u is computed as:

SKᵤ=(D,{Dᵢ}_{iε[1,k]},{Fᵢ}_{iε[1,k]}).

In some embodiments, each user u is tagged with the attribute list Lᵤ=Lᵤ⁺∪L_{ū} when joining the system. In some embodiments, Lᵤ⁺⊂{1, . . . ,k}, L_{ū}⊂{k+1, . . . ,2k}, and L*={2k+1, . . . ,3k}. The TA may select k random numbers r₁, r₂, . . . , rₖ from [symbol] ₚ and calculate r=Σᵢ₋₁^{k} rᵢ.

In some embodiments, the TA computes D=g^{γr}=v^{r}. For every iεLᵤ⁺, the TA may calculate Dᵢ=g^{γ(a}^{ⁱ}^{+r}^{_{i′}}⁾ where i′=i. For every iεL_{ū}, TA may calculate Dᵢ=g^{γ(a}^{ⁱ}^{+r}^{_{i′}}⁾ where i′=i−k. For every iεL*, TA may calculate Fᵢ=g^{γ(a}^{ⁱ}^{+r}^{_{i′}}⁾ where i′=i−2k.

In some embodiments, a private key for user u is computed as:

SKᵤ=(D,{Dᵢ|∇iεLᵤ⁺},{Dᵢ∇iεL_{ū}},{Fᵢ|∇iεL*}).

In some embodiments, the encryptor picks a random t in [symbol] ₚ and sets the one-time symmetric encryption key Key=e(g_{K}, g₁)^{kt}. In some embodiments, an AND-gate policy is W with k attributes. Each attribute may be either positive/negative or wildcards.

In some embodiments, the encryptor first encrypts the message using symmetric key Key as {M}_{Key}. The encryptor may also set C₀=g^{t}. Then, the encryptor may calculate C₁=(vΠ_{jεW} g_{K+1-j})^{t}. In some embodiments, the ciphertext is:

$$\begin{matrix}CT = ( W , {\{ M \}}_{K ey ,} {g}^{t} , {( v {Π}_{j ∈ W} {g}_{K + 1 - j} )}^{t} ) \\ = ( W , {\{ M \}}_{K ey} , {C}_{0} , {C}_{1} )\end{matrix}$$

In some embodiments, before performing decryption, the decryptor u has little information about the access policy that enforced over the ciphertext. In some embodiments, only if L|=W can u successfully recover the valid plaintext and access policy. Otherwise, u can only get a random string which can be easily detected. Moreover, the access policy may remain unknown to the unsuccessful decryptors.

In some embodiments, u constructs a local guess of access policy, denoted as \tilde{W}, as follows:

Algorithm 1 Construct local guess \tilde{W}

```
Initialize \tilde{W} = W̅
for i = 1 to k do
  if W̅[i] == Aᵢ* then
    \tilde{W}[i] = Lᵤ[i];
  end if
end for
return \tilde{W};
```

For ∇iε[1,k], u may calculate the T₀ and T₁ as follows:

$$\begin{matrix}{T}_{0} = e ( {g}_{\tilde{W} [ i ]} , {C}_{1} ) \\ = e ( {g}^{{α}^{\tilde{W} [ i ]}} , {g}^{t ( γ + {Σ}_{j ∈ \tilde{W}} {α}^{K = 1 - j} )} ) \\ = {e ( g , g )}^{t {γα}^{\tilde{W} [ i ]} + {Σ}_{j ∈ \tilde{W}} {α}^{L + 1 - j + \tilde{W} [ i ]}}\end{matrix}$$

and if \tilde{W}[i]εLᵤ, u may compute:

$$\begin{matrix}{T}_{1} = e ( D [ i ] \cdot {Π}_{j ∈ \tilde{W} , j \neq \tilde{W} [ i ]} {g}_{K + 1 - j + \tilde{W} [ i ]} , {C}_{0} ) \\ = e ( {g}^{t} , {g}^{γ ( {α}^{\tilde{W} [ i ]} + {r}_{i} ) + {Σ}_{j ∈ \tilde{W} , j \neq \tilde{W} [ i ]} {α}^{K + 1 - j + \tilde{W} [ i ]}} ) \\ = {e ( g , g )}^{t γ ( {α}^{\tilde{W} [ i ]} + {r}_{i} ) + t {Σ}_{j ∈ \tilde{W} , j \neq \tilde{W} [ i ]} {α}^{K + 1 - j + \tilde{W} [ i ]}}\end{matrix}$$

Else, if \tilde{W}[i]ε{Δᵢ*}_{iε[1,k]}, u may compute:

$$\begin{matrix}{T}_{1} = e ( F [ i ] \cdot {Π}_{j ∈ \tilde{W} , l \neq \tilde{W} [ i ]} {g}_{K + 1 - j + \tilde{W} [ i ]} , {C}_{0} ) \\ = e ( {g}^{t} , {g}^{γ ( {α}^{\tilde{W} [ i ]} + {r}_{i} ) + {Σ}_{j ∈ \tilde{W} , j \neq \tilde{W} [ i ]} {α}^{K + 1 - j + \tilde{W} [ i ]}} ) \\ = {e ( g , g )}^{t γ ( {α}^{\tilde{W} [ i ]} + {r}_{i} ) + t {Σ}_{j ∈ \tilde{W} , j \neq \tilde{W} [ i ]} {α}^{K + 1 - j + \tilde{W} [ i ]}}\end{matrix}$$

Then, is may be calculated:

T₀/T₁=e(g,g)^{-tγr}^{ᵢ}^{+ta}^{^{K+1}}.

In some embodiments, after u calculates all k terms, a production of all the quotient terms may be made to get:

e(g,g)^{-tγ(r}^{₁}^{+r}^{₂}^{+ . . . +r}^{ₖ}^{)+kta}^{^{k+1}}=e(g,g)^{-tγr}^{ᵢ}^{+ta}^{^{K+1}}.

u calculates:

e(D,C₀)=e(g,g)^{tγr}.

In some embodiments, u produces these two terms and gets Key=e(g, g)^{kta}^{^{K+1}}=e(g_{K}, g₁)^{kt} to decrypt the message. In some embodiments, if the decrypted message is valid, \tilde{W}=W and u decrypt the ciphertext successfully. Otherwise, u may have no information on the W and the anonymity set of \tilde{W} may not change.

In some embodiments, Chosen Plaintext Attack (CPA) security may be reduced to decisional K-BDHE assumption. A decryption proxy to model collusion attackers may be defined.

In some embodiments, a CP-ABE scheme is considered to be secure against chosen CPA if no probabilistic polynomial-time adversaries have non-negligible advantages. This may be demonstrated in an exemplary security game.

Init:

An adversary may choose the challenge access policy W and may give it to a challenger.

Setup:

The challenger may run the Setup algorithm and give adversary the PK.

Phase 1:

The adversary may submit L for a KeyGen query, where L≠W. The challenger may answer with a secret key SK for L. This step can be repeated adaptively.

Challenge:

The challenger may run Encrypt algorithm to obtain {<C₀, C₁>, Key}. The challenger may then pick a random bε{0,1}. The algorithm may set Key₀=Key and may pick a random Key₁ with same length to Key₀. The algorithm may then give {<C₀, C₁>, Key} to the adversary.

Phase 2:

Same as Phase 1.

Guess:

The adversary may output its guess b′ε{0,1} and may win the game if b′=b.

In some embodiments, the adversary may make multiple secret key queries both before and after the challenge. This may result in collusion resistance. This CPA security game may be called selective ID security because the adversary must submit a challenge access structure before the setup phase.

In some embodiments, if a probabilistic polynomial-time adversary wins the CPA game with non-negligible advantage, a simulator can be constructed that may distinguish a K-DBHE tuple with non-negligible advantage.

In some embodiments, CPA security can be reduced to decisional K-BDHE assumption. A decryption proxy may be defined to model collusion attackers. In order to model the collusion attacks, 2k decrypting proxies may be defined in the security game. Each decrypting proxy may be pᵢ(r)=g^{γ(a}^{ⁱ}^{+r)}, where rε [symbol] ₚ and iε{1, . . . ,2k}, i.e., a private key component corresponding to a particular attribute value.

In collusion attacks against access policy W, a user with attribute list L∥≠W may collude with x≦k decryption proxies to attack the ciphertext. This colluding with x decryption proxy may be called x-collusion. In some embodiments, x-collusion means the attacker needs x attributes values, say{i₁, i₂, . . . iₓ} to add to his attribute list L such that L∪{(i₁, i₂, . . . iₓ}|=W. In some embodiments, 0-collusion means no decryption proxy is used and user does not collude.

As an example, an adversary [symbol] may win the selective game for PPC-CP-ABE with the advantage ε. A Simulator [symbol] may be constructed that breaks decisional K-BDHE assumption with the advantage max {ε/2, (1−q/p)¹ε/2, (1−(1−(1−q/p)^{l})^{m})ε/2}. The simulator [symbol] may take as an input a random decisional if-BDHE challenge

[symbol]

h,g,Y_{g,a,K},Z

[symbol]

where Z is either g,h)^{a}^{^{(K+1)}} or a random element on [symbol] ₀. [symbol] may then play the role of challenger in a pre-defined CPA game with the following exemplary steps:

Init:

[symbol] may send to [symbol] the access policy W that [symbol] wants to be challenged.

Setup:

B may run the Setup algorithm to generate PK. [symbol] may choose random dε [symbol] ₚ and generate:

$$v = {{g}^{d} ( {Π}_{j ∈ W} {g}_{K + 1 - j} )}^{- 1} = {g}^{d - {Σ}_{j ∈ W} {α}^{K + 1 - j}} = {g}^{γ} .$$

The [symbol] may output the PK as:

PK=(g,Y_{g,a,K},v)ε [symbol] ₀^{2K+1}

Phase 1:

The adversary [symbol] may submit an attribute list L for a private key query, where L|≠W. Otherwise, the simulator may quit. The simulator [symbol] may select k random numbers rᵢε [symbol] ₚ for i=1 . . . k and set r=r₁+ . . . +rₖ. Then, [symbol] may generate

$$\begin{matrix}D = {( {g}^{d} {{Π}_{j ∈ W} ( {g}_{K + 1 - j} )}^{- 1} )}^{r} \\ = {g}^{( d - {Σ}_{j ∈ W} {α}^{K + 1 - j} ) r} \\ = {g}^{γ r}\end{matrix}$$

For ∇iε[1,k] and W[i]!=L[i], B may generate:

$${D}_{i} = {{g}_{L [ i ]}^{d} ( {Π}_{j ∈ W} {g}_{K + 1 - j + L [ i ]} )}^{- 1} {g}^{{ur}_{i}} {{Π}_{j ∈ W} ( {g}_{K + 1 - j} )}^{- {r}_{i}} ,$$

For ∇iε[1,k] and W [i]!=L[i]=Aᵢ*, [symbol] may generate:

$${F}_{i} = {{g}_{L [ i ]}^{d} ( {Π}_{j ∈ W} {g}_{K + 1 - j + L [ i ]} )}^{- 1} {g}^{{ur}_{i}} {{Π}_{j ∈ W} ( {g}_{K + 1 - j} )}^{- {r}_{i}} ,$$

Each Dᵢ or Fᵢ may be valid since:

$${D}_{i} = {( {{g}^{d} ( {Π}_{j ∈ W} {g}_{K + 1 - j} )}^{- 1} )}^{( {α}^{L [ i ]} + {r}_{i} )} = {g}^{γ ( {α}^{L [ i ]} + {r}_{i} )}$$

$$and$$

$${F}_{i} = {( {{g}^{d} ( {Π}_{j ∈ W} {g}_{K + 1 - j} )}^{- 1} )}^{( {α}^{2 k + i} + {r}_{i} )} = {g}^{γ ( {α}^{2 k + i} + {r}_{i} )}$$

Challenge:

The simulator [symbol] may set [symbol] C₀, C₁ [symbol] as [symbol] h,h^{d} [symbol] . It then may give the challenge { [symbol] C₀, C₁ [symbol] Z^{k}} to [symbol] . The validity of challenge may be shown as C₀=h=g^{t} for some unknown

t. Then:

$$\begin{matrix}{h}^{d} = {( {g}^{d} )}^{t} \\ = {( {g}^{e} {{Π}_{j ∈ W} ( {g}_{K + 1 - j} )}^{- 1} {Π}_{j ∈ W} ( {g}_{K + 1 - j} ) )}^{t} \\ = {( v {Π}_{j ∈ W} ( {g}_{K + 1 - j} ) )}^{t}\end{matrix}$$

and if Z=e(g, h)^{a}^{^{(K+1)}} then Z^{k}=Key.

Phase 2:

Repeat as Phase 1.

Guess:

The adversary [symbol] may output a guess b′ of b. When b′=0, [symbol] may guess that Z=e(g, h)^{a}^{^{(K+1)}}. When b′=1, [symbol] may guess Z is a random element. If Z is a random element, then the Pr[ [symbol] (h, g, Y_{g,a,K},Z)=0]=½

In some embodiments, a decryption proxy may be used. Each decryption proxy pᵢ(r) may simulate a legal private key component embedded with random number r. When calling pᵢ(r), [symbol] may pass a random r as a guess of the rᵢ′, which is the random number embedded in the Dᵢ or Fᵢ, where iεW. In some embodiments, the procedure of calling a decryption proxy mimics the collusion of multiple users, who combine their private key components.

As an example, JA may issue q private queries and may only have one attribute iεW. [symbol] may query pᵢ(r) l times. The possibility that none of the queries returns a legal private key component of any q may be (1−q/p)^{l}. Thus, if none of the l query succeed, the probability Pr[r≠r_{i′}]=(1−q/p)^{l}, where r is the random number in decryption proxy, r_{i′} is the random number embedded in the private key, q is the number of private key queries in phase 1 and phase 2, l is the number of calling decryption proxy with different r, and p is the order of [symbol] ₚ.

As an example, [symbol] may issue q private queries and m attributes may violate the W. [symbol] may query each of the m decryption proxy Pᵢ_{₁}(r₁), Pᵢ_{₂} (r₂), . . . Pᵢ_{ₘ} (rₘ) l times. The possibility that none of the queries returns a legal private key component of any q is (1−(1−q/p)^{l})^{m}. Pr[r≠r_{i′}]=(1−q/p)^{l}. The probability that one decryption proxy fails is Pr[r≠r_{i′}]=(1−q/p)^{l}. The probability that all the m decryption proxy successfully return legal components is (1−(1−(q/p)^{t}))^{m}. In the case of not all m succeed, the probability is Pr[rᵢ_{ⱼ}≠r_{i′}_{_{j′}}∃j≦m]=1−(1−(1−q/p)^{l})^{m}.

In some embodiments, if Z=e(g,h)^{a}^{^{(K+1)}} we consider the following eases:

0-Collusion:

If no decryption proxy is used, [symbol] may have at least ε/2 advantage in breaking the PPC-CP-ABE scheme. [symbol] may have at least ε advantage in breaking K-BDHE, i.e.,

|Pr[ [symbol] (h,g,Y_{g,a,K},Z)=0]−1/2|≧ε/2

l-Collusion:

If one decryption proxy, say pᵢ(r) is used, Pr[r≠r_{i′}]=(1−q/p)^{l} where r is the random number in decryption proxy, r_{i′} is the random number embedded in the private key, q is the number of private key queries in phase 1 and phase 2, l is the number of calling decryption proxy with different r, and p is the order of [symbol] ₚ. If r=r_{i′}, [symbol] can use pᵢ(r) as a valid private key component to compromise the ciphertext. If the A has at least ε advantage in breaking the PPC-CP-ABE scheme, then [symbol] has at least (1−q/p)^{l}ε/2 advantage in breaking K-BDHE.

m-Collusion:

If m decryption proxies, say pᵢ_{₁}(r₁), p₁_{₂}(r₂), . . . , pᵢ_{ₘ}(rₘ) are used, the possibility that Pr[rᵢ_{ⱼ}≠r_{i′}_{_{j′}}∃j≦m]=1−(1−(1−q/p)^{l})^{m}, where rₘ is the random number in m decryption proxy Pᵢ_{ₘ} (rₘ) for the private key component lₘ, r_{i′}_{ₘ} is the random number generated for the [symbol] , q is the number of private key queries in phase 1 or phase 2, l is the number of calling m decryption proxies with different r's, and p is the order [symbol] ₚ. If the [symbol] has at least ε advantage in breaking the PPC-CP-ABE scheme, then [symbol] has at least (1−(1−(1− [symbol] q/p)^{l})^{m})ε/2 advantage in breaking K-BDHE.

### Privacy Preserving Attribute Based Broadcast Encryption

In some embodiments of PPC-CP-ABE, an efficient and flexible Broadcast Encryption (BE) scheme—Privacy Preserving Attribute Based Broadcast Encryption (PP-AB-BE), is constructed, where the size of a ciphertext is still constant.

In some embodiments, when using PP-AB-BE, an encryptor does not need to store a large number of key materials, i.e., public key and private key compared to existing BE schemes. By carefully organizing the attributes in the system, the storage overhead of each user can be reduced from O(N) to O(log N+m), where N is the number of users in the system and m<<N is the number of descriptive attributes in the system.

In some embodiments, when using PA-AB-BE, an encryptor enjoys the flexibility of encrypting broadcast data using either a specific list of decryptors or an access policy without giving an exact list of decryptors.

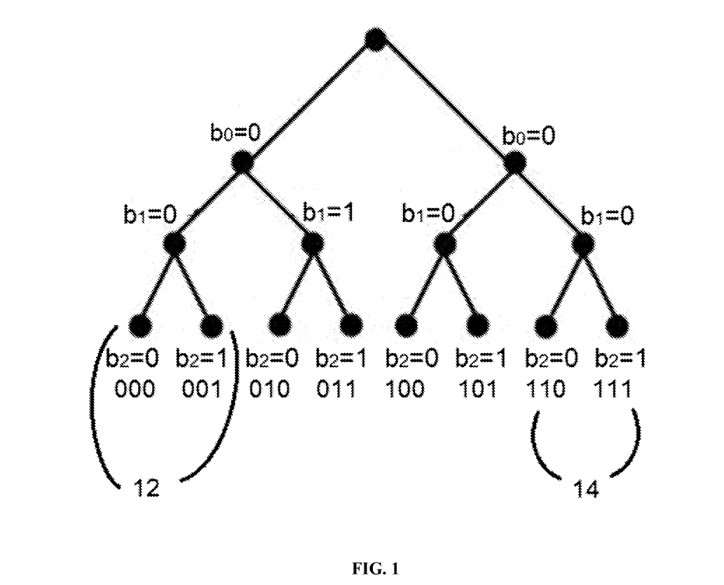

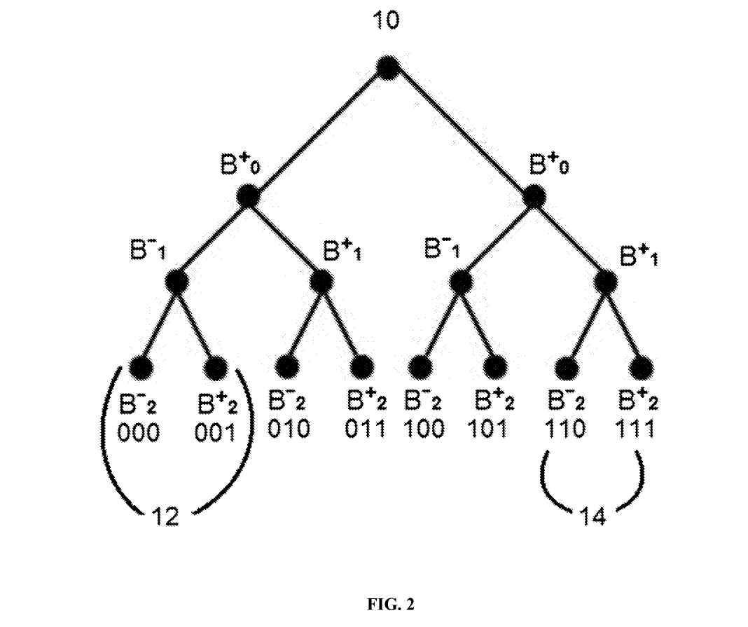

FIGS. 1-2 illustrates an exemplary embodiment of a system 10 with eight possible users. Each user 12 may be assigned 3 bit-assignment attributes 14 to represent the bit values in their ID. In some embodiments, in PP-AB-BE with N users, each user is issued an n-bit binary ID b₀b₁, . . . bₙ, where bᵢ represents the i'th bit in the user's binary ID, where n=log N. Accordingly, we can define n bit-assignment attributes {B₁, B₂, . . . , Bₙ}. Each user may be assigned n bit-assignment attribute values according to his/her ID. If the bᵢ=1, he/she may be assigned the Bᵢ⁺, if the bᵢ=0, he/she may be assigned the Bᵢ⁻.

In some embodiments, given the n=log N the bit-assignment attributes, TA may generate 3n attributes values, i.e., bit-assignment attribute Bᵢ has {Bᵢ⁺, Bᵢ⁻, Bᵢ*} values.

In some embodiments, in addition to the bit-assignment attributes, the TA may also choose m descriptive attributes for the system. These descriptive attributes may present the real properties or features of an entity, which can be used to describe the decryptors' social or role features, e.g., “CS”, “EE”, “Student”, “Faculty”, etc. Each of the m descriptive attributes may have {1,0,*] values.

In some embodiments, with the 3n+3m attribute values, the authority runs Setup (n+m) algorithm and generate public keys and private keys.

In some embodiments, in order to control the access to the broadcasted message, the sender needs to specify an access policy using either the descriptive attributes or bit-assignment attributes. For example, if Alice wants to send a message to all CS students, she can specify the descriptive policy W₁ in Table IV below. If she wants to send a message to Bob and Carol, whose ID are 100 and 101 respectively, she can use the bit-assignment policy W₂, which is equivalent to enumerate every receiver.

TABLE IV
Sample Policies

| | CS | EE | Student | Faculty | B₀ | B₁ | B₂ |
|---|---|---|---|---|---|---|---|
| W₁ | A₁⁺ | A₂⁻ | A₃⁺ | A₄⁻ | B₀* | B₁* | B₂* |
| W₂ | A₁* | A₂* | A₃* | A₄* | B₀⁺ | B₁⁻ | B₂* |

In some embodiments, an encryptor can specify a list of receivers explicitly using n bit-assignment attributes. For illustrative purposes, some of the terms used in the following presentations are defined as follows:

Literal: A variable or its complement, e.g., b₁, b̅₁, etc.

Product Term: Literals connected by AND, e.g., b̅₂b̅₁b̅₀

Sum-of-Product Expression (SOPE): Product terms connected by OR, e.g., b̅₂b̅₁b̅₀+b₂.

In some embodiments, given the set of receivers S, the membership functions ƒₛ( ), which is in the form of SOPE, specifies the list of receivers:

$$fs ( {b}_{1}^{u} , {b}_{2}^{u} , … , {b}_{u}^{n} ) = \{ \begin{matrix}0 iff i ∈ S , \\ 0 iff u ∉ S .\end{matrix}$$

In some embodiments, if the subgroup S={000, 001,011,111}, then ƒₛ=b̅₀b̅₁b̅₂+b̅₀b̅₁b̅₂+b̅₀b̅₁b̅₂.

In some embodiments, the broadcast encryptor runs a Quine-McCluskey algorithm to reduce ƒₛ to minimal SOPE ƒₛ^{min.} The reduction can consider do not care values * on those IDs that are not currently assigned to any receiver to further reduce number of product terms in the membership function. For example, if S={000, 001,011,111}, ƒₛ^{min}=b̅₀b̅₁+b̅₁b̅₂

In some embodiments, since ƒₛ^{min} is in the form of SOPE, encryption is performed on each product term. That is, for each product term E in ƒₛ^{min}, the encryptor may specify an AND-gate access policy W using the following rules:

1—For positive literal bᵢεƒₛ^{min}, set Bᵢ⁺ in the access policy W
2—For negative literal b̅ᵢεƒₛ^{min}, set Bᵢ⁻ in the access policy W.
3—Set Bᵢ* for the rest of bit-assignment attributes.

In some embodiments, for each W, the encryptor uses Encrypt (PK, W, M) algorithm to encrypt the message. The total number of encrypted message may be equal to the number of product terms in ƒₛ^{min}.

In some embodiments, if S={000, 001,011,111}, ƒₛ^{min}=b̅₀b̅₁+b₁b₂The access policies W₁ and W₂ are shown in Table V:

TABLE V
Sample Policies

| | CS | EE | Student | Faculty | B₀ | B₁ | B₂ |
|---|---|---|---|---|---|---|---|
| W₁ | A₁* | A₂* | A₃* | A₄* | B₀⁻ | B₁⁻ | B₂* |
| W₂ | A₁* | A₂* | A₃* | A₄* | B₀* | B₁⁺ | B₂⁺ |

In some embodiments, ƒₛ^{min} min contains 2 product terms. The message M for S can be encrypted into 2 ciphertexts with W₁ and W₂ respectively.

In some embodiments, to be uniquely identified, each user's ID should not be prefix of any other user's. For example, suppose a user u′ is issued an ID 00, which is prefix of u₁ with ID 000 and u₂ with ID 001. When an encryptor tries to reach u₁ and u₂, the minimized membership function may be ƒ=x̅₀x̅₁, which may also be satisfied by u′. Thus, it may also be imperative that a user's bit-assignment attributes should not be a prefix of any other user's.

In some embodiments, a number of bit-assignment attributes (or number of bits in the ID) may be denoted for a user uᵢ by lᵢ. For an attribute based encryption system with N users and the attribute lists of users satisfying the prefix-free condition, the set {1₁, 1₂, . . . , l_{N}} may satisfy the Kraft inequality:

$${\sum }_{i = 1}^{N} {d}^{- {l}_{t}} \leq 1.$$

In some embodiments, the prefix free condition is a necessary and sufficient condition for addressing any user with their bit-assignment attributes.

In some embodiments, for a message addressed to one particular user, pᵢ is used to denote the possibility that a user uᵢ is the target. The ability to address to any one of the users may be the necessary condition for a functioning broadcast encryption. To reach a receiver uᵢ, the encryptor may need lᵢ bit-assignment attributes, i.e., storage overhead of lᵢ. From the sender's perspective, the storage overhead may be modeled as:

$${\sum }_{i = 1}^{N} {p}_{i} {l}_{i} .$$

In some embodiments, this formation argues that the storage overhead from a sender's perspective is the average number of bit-assignment attributes required to address to a particular users. Thus, an optimization problem may be formulated to minimize the storage overhead for a broadcast encryption system:

$${min}_{{l}_{i}} {\sum }_{i = 1}^{N} {p}_{i} {l}_{i}$$

$$s . t . \\ {\sum }_{i = 1}^{N} {d}^{- {l}_{i}} \leq 1.$$

This problem can be further rewritten as a Lagrangian optimization problem as:

$${min}_{{l}_{i}} \{ {\sum }_{i = 1}^{N} {p}_{i} {l}_{i} + λ ( {\sum }_{i = 1}^{N} {d}^{- {l}_{i}} - 1 ) \} ,$$

where λ is the Lagrangian multiplier. The optimization problem may be identical to the optimal codeword-length selection problem in information theory. The entropy H of targeting a user in the broadcast encryption system is

$$H = - {\sum }_{i = 1}^{N} {p}_{i} log {p}_{i} .$$

In some embodiments, for an broadcast encryption system of N users with prefix free distribution of bit-assignment attributes, the optimal (i.e., minimal) average number of attributes required for a sender to address a receiver, written as Σᵢ₌₁^{N} pᵢlᵢ is given by the binary entropy

$${H}_{d} = - {\sum }_{i = 1}^{N} {p}_{i} log {p}_{i} .$$

In some embodiments, since the average number of attributes required for addressing one particular receiver is given by the entropy of targeting a user, the upper and lower bounds of the entropy can be derived:

$${max}_{{p}_{i}} - {\sum }_{i = i}^{N} {p}_{i} log {p}_{i}$$

$$and$$

$${min}_{{p}_{i}} - {\sum }_{i = i}^{N} {p}_{i} log {p}_{i}$$

$$s . t . \\ {\sum }_{i = 1}^{N} {p}_{i} = 1.$$

In some embodiments, the upper bound

$${H}_{max} = - {\sum }_{i = 1}^{N} \frac{1}{N} log N = log N$$

is yielded when pᵢ=1/N, ∇iε{1,2, . . . , N}, when each user has equal possibility to be addressed as the receiver. l=Hₘₐₓ=log_{d} N may correspond to the optimal strategy to minimize the average number of attributes required for each user when there is no a priori information about the possibility distribution of targeting one of the users. On the other hand, the lower bound Hₘᵢₙ=0 may be achieved when pᵢ=1 for ∃iε{1,2, . . . ,N}, which is an extreme case where there is no randomness and only one user is reachable.

These methods can be compared with a BGW BE scheme. In some embodiments, optimal bit-assignment attributes assignment may be minimalist, which requires the least number of bit-assignment attributes to identity each user. In some embodiments, a BGW scheme is maximalist. In some embodiments, in a BGW scheme, for a system with N users, each user is mapped to a unique public key. Given all N public keys, the number of combinations is 2^{N}−1, which is equal to the number of receiver subsets in the system. Thus, each encryptor may need a maximal number of public keys to perform broadcast encryption.

To compare the minimalist and maximalist storage strategy, we can treat each attribute or public key as an binary variable vε{1.0}. We denote p=Pᵥ₌₁ as the percentage of totals users who have this attributes or public key and 1−p=Pᵥ₌₀ as the percentage of totals users who do not have this attributes or public key, given that P₍ᵥ₌₁₎+P₍ᵥ₌₀₎=1.

In some embodiments, the entropy of an attribute or a public key is defined as:

H(v)=p log p⁻¹+(1−p)log(1−p)⁻¹.

In some embodiments, the entropy of an attribute in minimalist strategy is Hₐ (1/2)=1. For each particular attribute, exactly half of the users have it while the other half do not have it. On the other hand, the entropy of a public key in maximalist strategy is Hₐ(1/N)=(1/N) log(N)+((N−1)/N) log(N/(N−1))<1. Hence, minimalist strategy may attain maximal binary entropy while the maximalist strategy may attain minimal binary entropy.

### System Performance Assessment

In some embodiments, the performance of PP-AB-BE may be assessed in terms of communication overhead (number and size of messages), storage overhead (system data stored on the users and system centers), and computation overhead (number of cryptographic operations needed in encryption and decryption operations) when a user talks to any given subgroup of users in the system. In some embodiments, the group size may be N.

A complexity analysis of communication overhead for various schemes is summarized in Table VI.

TABLE VI
Comparison of communication overhead and storage overhead in different
broadcast encryption schemes and group key management schemes.

| | Communication Overhead | | Storage Overhead | |
|---|---|---|---|---|
| Scheme | single receiver | multiple receivers | Center | User |
| ABBE | O(1) | ≈O(log N) | N/A | O(log N + m) |
| Subset-Diff | O(t² · log² t · log N) | O(t² · log² t · log N) | O(N) | O(t log t log N) |
| BGW₁ | O(1) | O(1) | N/A | O(N) |
| BGW₂ | O(N^{½}) | O(N^{½}) | N/A | O(N^{½}) |
| NNL₁ | N/A | O(t log(N/t)) | N/A | O(log N) |
| NNL₂ | N/A | O(t) | N/A | O(log² N) |
| DPP₁ | O(1) | O(1) | N/A | O(N) |
| DPP₂ | N/A | O(t) | N/A | O(1) |
| BW | O(N^{½}) | O(N^{½}) | N/A | O(N^{½}) |
| LT | N/A | O(t) | N/A | O(log N) |
| ACP | O(N) | O(N) | O(N) | O(1) |
| Flat-Table | O(log N) | ≈O(log² N) | O(log N)/O(N) | O(log N) |
| Flat-Table-ABE | O(log N) | ≈O(log N) | O(log N)/O(N) | O(log N) |
| Non-Flat-Table-Tree | O(log N) | O(l · log N) | O(N) | O(log N) |

N: the number of group members; l: the number of leaving members; t: maximum number of colluding users to compromise the ciphertext.

In a Subset-Diff scheme, the communication overhead may be O(t²·log²t·log N), with t as maximum number of colluding users to compromise the ciphertext. For a BGW scheme, the message size may be O (N½). In an ACP scheme, the size of a message may depend on the degree of access control polynomial, which equals to the number of current receivers. Thus, the message size may be O(N).

For non-flat-table tree-based multicast key distribution schemes, the communication overhead for removing members may depend on the number of keys in the tree that need to be updated. In some embodiments, if a single member is removed, O(log N) messages are required since the center needs to update log N auxiliary keys distributed to the removed member. Some tree-based schemes try to optimize the number of messages to update all the affected keys in the case of multiple leaves. In an ELK scheme, known to be one of the most efficient tree-based schemes, the communication overhead for multiple leaves is O(a−1), where a I log N is the number of affected keys and I is the number of leaving members. Thus, the complexity can be written as O(l log N).

For flat-table tree-based schemes, the complexity of removing a single member is also O(log N). The main benefit of a flat-table scheme is the minimal number of messages for batch removing multiple members. Some embodiments of the PP-AB-BE scheme require the same number of messages as flat-table schemes. Thus, both schemes achieve information theoretical optimality. However, flat-table is vulnerable to collusion attacks. Some embodiments of the PP-AB-BE scheme implement flat-table using CP-ABE to counter collusion attacks.

In some embodiments, to control a set of receivers S using PP-AB-BE, the number of messages depends on the number of product terms in the ƒₛ^{min}. Some embodiments of the PP-AB-BE scheme have an upper bound and lower bound on the average number of product terms in a minimized SOPE. Experimentally, the average number of message required is ≈l log N.

In some embodiments, a maximal number of messages is required to reach multiple receivers. A worst case of reaching multiple receivers may happen when both of two conditions hold: 1) the number of distinct receivers is N/2, and 2) the Hamming distance between IDs of any two receivers is at least 2. In a worst case, the number of key updating messages is N/2. In this case, the number of messages is N−N/2=N/2 using PP-AB-BE. However, there is an extremely low probability that the worst cases occurs. When communicating all subgroups with uniform opportunity, the worst case scenario may occur with probability

$$\frac{1}{{2}^{N - 1}} .$$

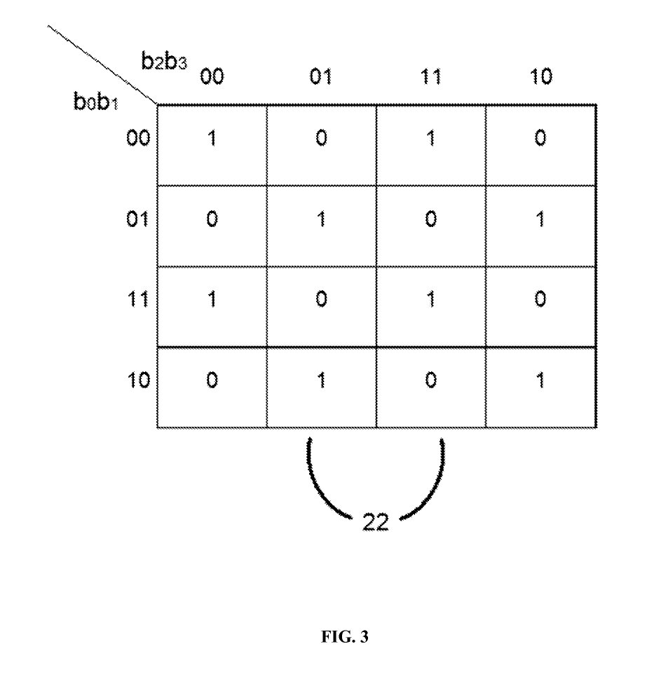

In some embodiments, in a worst case, the Hamming distance of IDs of N/2 receivers should be at least 2. FIG. 3 shows an exemplary Karnaugh table 20 for a worst case. Each cell 22 represents an ID. For any cell marked 0 and any cell marked 1, the Hamming distance is at least 2. Thus, the worst cases happens in two cases: (1) when the encryptor wants to reach N/2 receivers marked 1, and (2) when the encryptor wants to reach N/2 receivers marked 0.

In some embodiments, there may also be a worst case for communicating to a majority of users. In some embodiments, when reaching N−2 receivers, the maximal number of messages required is n=log N, when the Hamming distance between 2 non-receivers is n.

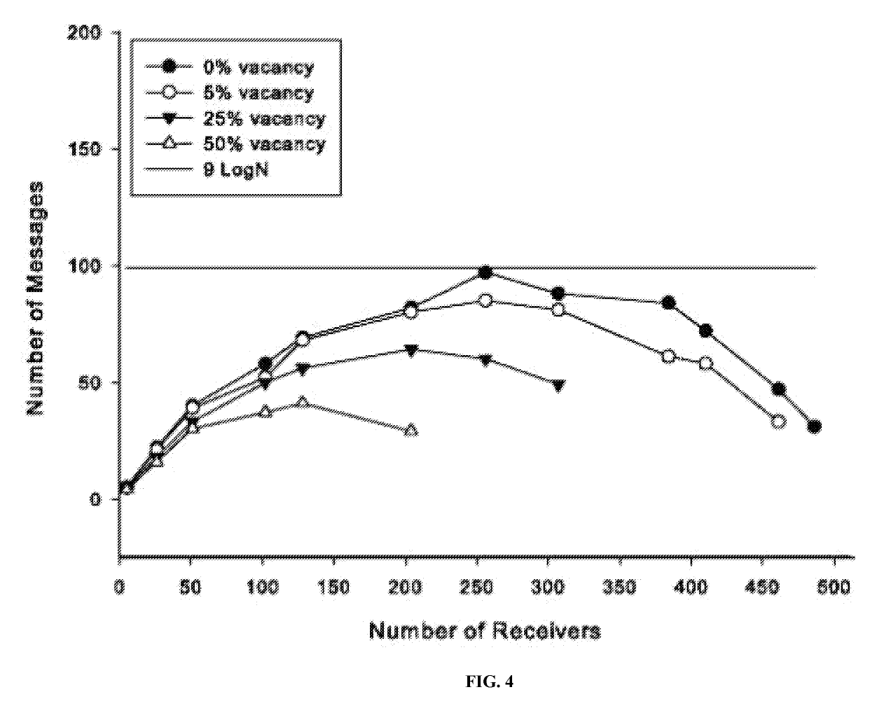

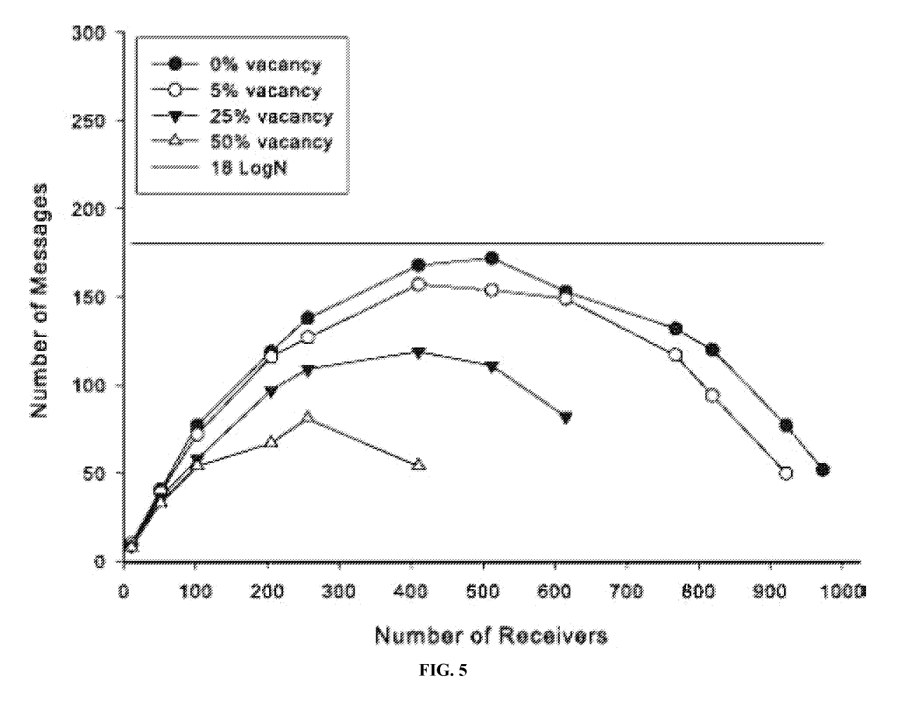

FIGS. 4 and 5 depict graphs 30, 40 that show a number of messages required in average cases in which PP-AB-BE may be used on a system with 512 users and 1024 users, respectively.

For purposes of example, the cases of 0%, 5%, 25%, 50% IDs are not assigned (i.e., do not care value). For each case, different percentages of receivers may be randomly selected from the group. In some embodiments, the process may be completed 100 times to average the results. From the result shown in FIGS. 4 and 5, PP-AB-BE performance achieves roughly O(log N) complexity, where the constant factor is about 9 for the 512-member group and 18 for the 1024-member group.

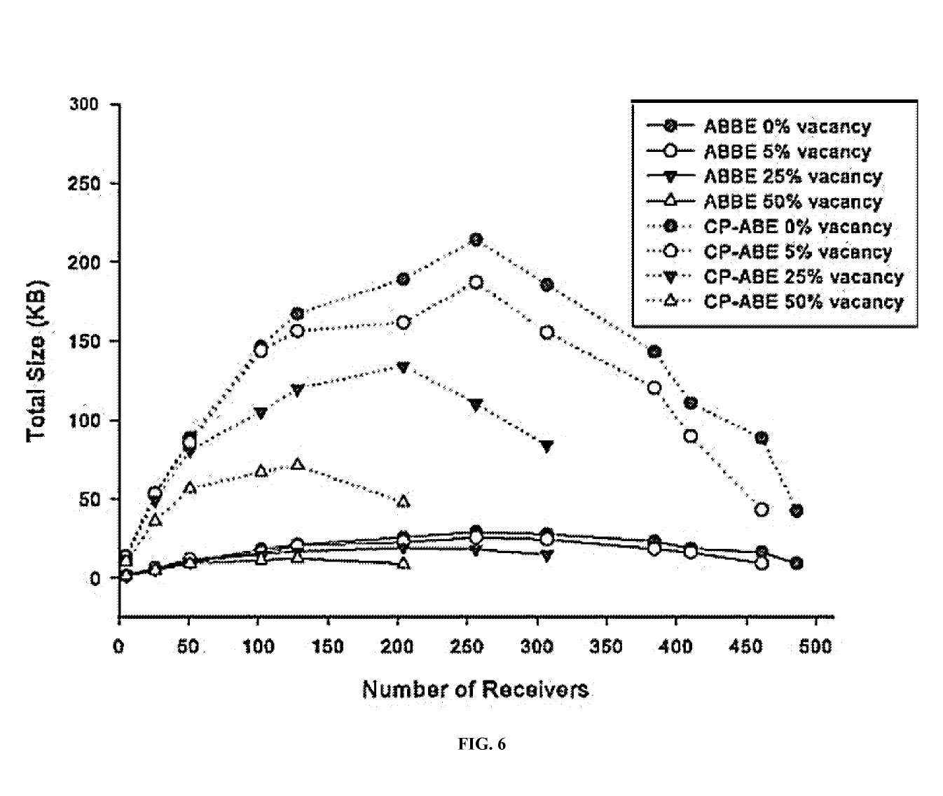

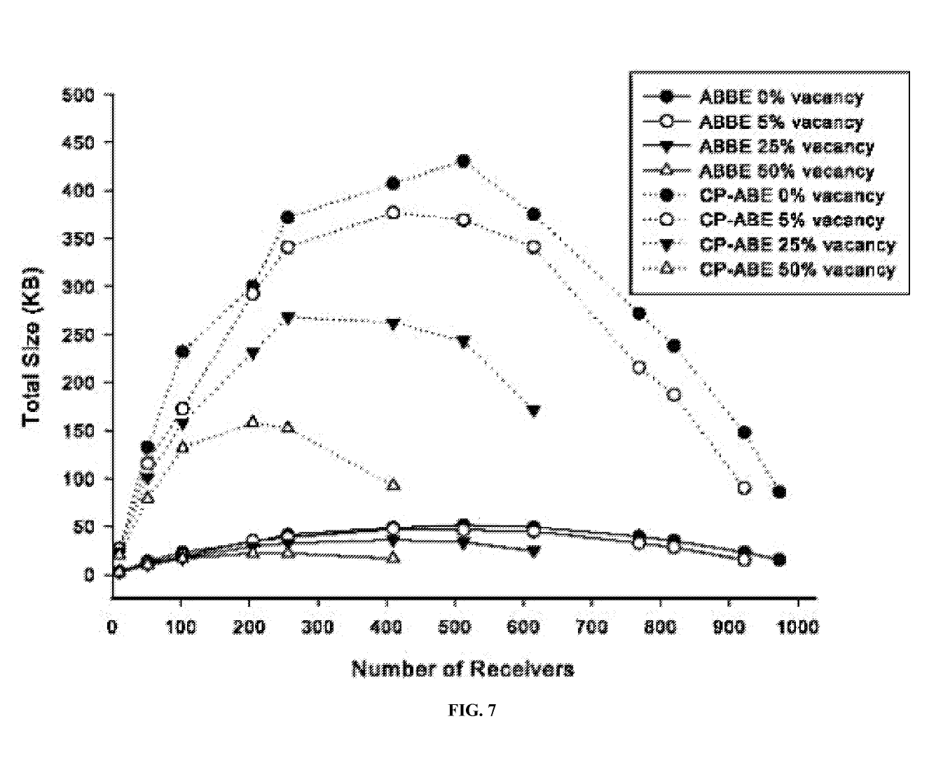

FIGS. 6 and 7 depict graphs 50, 60 that show a total size of messages in average cases in which PP-AB-BE may be used on a system with 512 users and 1024 users, respectively. A comparison of the message size of PP-AB-BE can be made with FT-CP-ABE. In FT-CP-ABE, the size of ciphertext grows linearly based on the increase of the number of attributes in the access policy. Experimentally, the message size in FT-CP-ABE starts at about 630 bytes, and each additional attribute adds about 300 bytes. In a system with 10 bit ID or 1024 users, the number of attributes using FT-CP-ABE ciphertext is at most 10 and the message size may be as large as 630+9·300=3330 bytes. Since the number of attributes in the access policy is bounded by log N, the communication overhead of FT-CP-ABE is in the order of O(log² N).

In some embodiments of PP-AB-BE, every ciphertext contains exactly 2 group member on [symbol] ₀. Empirically, the size of one element on G₀ may be about 128 bytes. Thus, the ciphertext in PP-AB-BE may be bounded within 300 bytes, which is significantly smaller than the ciphertext size reported in FT-CP-ABE. Moreover, since the component C₀ in the ciphertext can be shared by multiple messages, the message size of PP-AB-BE can be further reduced with efficient communication protocol design.

In some embodiments of PP-AB-BE, there are 6 log N+1 elements on [symbol] ₀ in the PK. Also, a user may need to store <<N descriptive attributes. Thus, the storage overhead may be O(log N+m), assuming a user does not store any IDs of other users. Although the broadcast encryptor may need the list of receivers' IDs along with the list of do not care IDs to perform boolean function minimization, this does not incur extra storage overhead.

In some embodiments, the encryptors do not need to store the receiver's IDs after the broadcast; thus, the storage space can be released.

In some embodiments, the TA can periodically publish the minimized SOPE of all do not care IDs, which can be used by encryptors to further reduce number of messages.

In some embodiments, if IDs are assigned to users sequentially, i.e., from low to high, TA can simply publish the lowest unassigned IDs to all users, who can use the all higher IDs as do not care values.

In some embodiments, even if a user needs to store N IDs, the space is merely N log N bits. If N=2²⁰.

In some embodiments, if a broadcast encryptor cannot utilize do not care values to further reduce the membership function in SOPE form, the communication overhead might be a little higher. As shown in FIGS. 4 and 5, the curve of 0% vacancy can also be used as a number of messages required if a broadcast encryptor does not know the do not care IDs.

A computation overhead of asymmetric key based schemes and summarized results are presented in Table VII.

TABLE VII
Comparison of computation complexity in
different broadcast encryption schemes.

Computation Overhead

| Scheme | Encryption | Decryption |
|---|---|---|
| ABBE | O(log N) | O(log N) |
| BGW | O(M) | O(M) |
| ACP | O(M²) | O(1) |

N: the number of group members; M: the number of receivers.

In an ACP scheme, the encryption needs O(N²) finite field operations when the sub-group size is N. In the BGW scheme, the encryption and decryption require O(N) operations on the bilinear group, which are heavier than finite field operations. In some embodiments of PP-AB-BE, each encryption requires log N operations on the [symbol] ₀, and the decryption requires 2 log N+1 pairings and log N(log N−1)+log N operations on [symbol] ₀ and log N operations on [symbol] ₁. Thus, the complexities of encryption and decryption are bounded by O(log N). Although the problem of minimizing SOPE is NP-hard, efficient approximations are widely known. Thus, some embodiments of PP-AB-BE are much more efficient than ACP and BGW when group size is large.

### System Embodiments

Those of skill in the art will appreciate that the algorithms and method steps described in connection with embodiments disclosed herein can often be implemented as logic circuitry in electronic hardware, computer software, or combinations of both. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention.

Moreover, the various illustrative algorithms and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means- plus- or step-plus-function limitations, unless such a limitation is explicitly recited in a given claim using the phrase(s) “means for” or “step for,” respectively.

1. A method for providing attribute-based encryption of a message comprising:
generating a public key PK and a master key MK, each public key PK being mapped to an attribute value;
generating a private key for a user based on the public key PK, the master key MK and a user's attribute list L;
specifying an access policy W by assigning an attribute for each available attribute; and
producing cyphertext CT utilizing the public key PKs of the attribute values of the access policy W̅ and a message M as input, wherein the ciphertext associates an anonymized access policy W, and wherein only a user with an attribute list L satisfying the access policy W can decrypt the cyphertext CT.

2. The method of claim 1, wherein said access policy enforces hidden conjunctive access policies with wildcards in constant ciphertext size.

3. The method of claim 1, wherein the user's attribute list L is defined in accordance with the following definition:
Definition 1: A user's attribute list is defined as L={L[i]_{i ε[1,k]}}, where L[i]ε{Aᵢ⁺, Aᵢ⁻} and k is the number of attributes in the universe. □

4. The method of claim 1, wherein said method utilizes a hidden AND-gate policy constructed in accordance with the following definition:
Definition 2: Let W={W[i]}_{iε[1,k]} be an AND-gate access policy, where W[i]ε{Aᵢ⁺, Aᵢ⁻,Aᵢ*}. We use the notation L|=W to denote that the attribute list L of a user satisfies W, as:
L|=W [symbol] W⊂L∪{Aᵢ*}_{iε[i,k]}.□

5. The method of claim 1, wherein said method utilizes an anonymized AND-gate policy constructed in accordance with the following definition:
Definition 3. Let W̅=W∩{Aᵢ*}_{iε[i,k]} be an anomymized AND-gate access policy.

6. The method of claim 1, wherein an anonymity set of a blinded policy W̅ is a set of access policies which are identically blinded to W̅.

7. The method of claim 1, further comprising decrypting ciphertext CT using the public key PK, the private key SK of the user and the ciphertext CT if the user's attribute list L satisfies the anonymized access policy W̅.

8. The method of claim 7, wherein said decryption includes the step of constructing a local guess of access policy \check{W}.

9. The method of claim 8, wherein said step of constructing a local guess utilizes the following algorithm:
Algorithm 1 Construct local guess \tilde{W}
```
Initialize \tilde{W} = W̅
for i = 1 to k do
  if W̅[i] == Aᵢ* then
    \tilde{W}[i] = Lᵤ[i];
  end if
end for
return \tilde{W};
```

10. The method of claim 1, wherein said method is utilized for broadcast encryption.

11. A method of encrypting a message M for broadcast, comprising:
issuing each user an n-bit binary ID, wherein N represents the number of users and n=log N;
assigning each user bit-assignment attributes to represent bit values in their ID; choosing m descriptive attributes for the system;
generating public and private keys utilizing n and m;
specifying an access policy W utilizing either descriptive attributes or bit-assignment attributes; and
encrypting the message M utilizing an encryption algorithm utilizing public key and the access policy.

12. A non-transitory computer readable medium storing a program causing a computer to execute the following process:
generating a public key PK and a master key MK, each public key PK being mapped to an attribute value;
generating a private key for a user based on the public key PK, the master key MK and a user's attribute list L;
specifying an access policy W by assigning an attribute for each available attribute; and
producing cyphertext CT utilizing the public key PKs of the attribute values of the access policy W and a message M as input, wherein the ciphertext associates an anonymized access policy W̅, and wherein only a user with an attribute list L satisfying the access policy W can decrypt the cyphertext CT.

13. The non-transitory computer readable medium of claim 12, wherein said access policy enforces hidden conjunctive access policies with wildcards in constant ciphertext size.

14. The non-transitory computer readable medium of claim 12, wherein the user's attribute list L is defined in accordance with the following definition:
Definition 1: A user's attribute list is defined as L={L[i]_{iε[1,k]}}, where L[i]ε{Aᵢ⁺, Aᵢ⁻} and k is the number of attributes in the universe. □

15. The non-transitory computer readable medium of claim 12, wherein said method utilizes a hidden AND-gate policy constructed in accordance with the following definition:
Definition 2. Let W={W[i]}_{iε[1,k]} be an AND-gate access policy, where W[i]ε{Aᵢ⁺, Aᵢ⁻, Aᵢ*}. We use the notation L|=W to denote that the attribute list L of a user satisfies W, as:
L|=W [symbol] W⊂L∪{Aᵢ*}_{iε[1,k]}.□

16. The non-transitory computer readable medium of claim 12, wherein said method utilizes an anonymized AND-gate policy constructed in accordance with the following definition:
Definition 3. Let W̅=W∩{Aᵢ*}_{iε[1,k]} be an anomymized AND-gate access policy.

17. The non-transitory computer readable medium of claim 12, wherein an anonymity set of a blinded policy W̅ is a set of access policies which are identically blinded to W̅.

18. The non-transitory computer readable medium of claim 12, further comprising instructions for decrypting ciphertext CT using the public key PK, the private key SK of the user and the ciphertext CT if the user's attribute list L satisfies the anonymized access policy W̅.

19. The non-transitory computer readable medium of claim 18, wherein said decryption includes the step of constructing a local guess of access policy \check{W}.

20. The non-transitory computer readable medium of claim 19, wherein said step of constructing a local guess utilizes the following algorithm:
Algorithm 1 Construct local guess \tilde{W}
```
Initialize \tilde{W} = W̅
for i = 1 to k do
  if W̅[i] == Aᵢ* then
    \tilde{W}[i] = Lᵤ[i];
  end if
end for
return \tilde{W};
```
